(19) United States
(12) Patent Application Publication
(10) Pub. No.: US 2026/0350915 A1
(43) Pub. Date: Nov. 5, 2026

(54) GENERATING INTERACTIVE AND IMMERSIVE VIRTUAL AND AUGMENTED REALITY ENVIRONMENTS CORRESPONDING TO DIGITAL TWINS OF REAL-LIFE ELEMENTS

(71) Applicant: META LIVE INC., Vancouver (CA)

(72) Inventor: Allison MYERS, Saint Colomban (CA)

(21) Appl. No.: 19/487,033

(22) PCT Filed: May 27, 2024
(86) PCT No.: PCT/CA2024/050705

§ 371 Date: Nov. 24, 2025

Related U.S. Application Data
(60) Provisional application No. 63/504,614, filed on May 26, 2023.

(51) Int. Cl. G06T 15/20; G06T 19/00; H04N 21/218; H04N 21/81

(52) U.S. Cl. CPC G06T 15/20; G06T 19/006; H04N 21/21805; H04N 21/8146

(57) ABSTRACT

Method and a system for generating a digital twin of a live event for an interactive virtual environment. The system includes a server configured to receive video data streams and audio data streams. The server operates a computing module configured to analyze video data streams and corresponding metadata, to determine a spatial depth between images of video data stream, to match objects in each image to a coordinate matrix of a virtual space, to match the 3-D audio field to the coordinate matrix of the virtual space, to generate the digital twin of the live event based on the images, the corresponding metadata, the spatial depth, the predetermined set of coordinates and the coordinate matrix. The server is configured to generate a plurality of digital representations from multiple directions of the live event, including an at least one 360-degree digital representation and a plurality of unidirectional digital representations.

### CROSS-REFERENCE

This application claims priority from U.S. provisional patent applications 63/504,614 filed May 26, 2023. The content of which is hereby incorporated by reference.

### FIELD OF THE TECHNOLOGY

The present technology relates to electronic systems and methods for generating interactive virtual or augmented reality environments corresponding to digital twins of real-life elements, particularly related to live events, which include live events in the performance arts, music and sporting.

### BACKGROUND

Augmented reality and virtual reality applications are well known in the art. Some of these applications enhance a real-life experience with digital overlays using augmented reality technology. Other applications digitalize real-life elements to simulate them via virtual reality. For example, it is known to integrate into a metaverse, which is a digital virtual world, digital elements that aim to simulate for example, the laws of physics, where users can employ objects that are similar to real-life objects. This is well known in the art of the digital games.

However, there exists many technological problems that need to be solved in order to digitalize large scale live events as they are difficult to compute and feed to multiple users. The development of the technologies may provide suitable technological solutions in the future. In general, many patent documents teach various aspects of augmented reality and virtual reality technologies.

For example, U.S. Pat. No. 10,650,590 for Method and system for fully immersive virtual reality by Pankaj N. Topiwala et al., granted May 12, 2020, teaches methods and systems that use a video sensor grid over an area, and extensive signal processing, to create a model-based view of reality. Grid-based synchronous capture, point cloud generation and refinement, morphology, polygonal tiling and surface representation, texture mapping, data compression, and system-level components for user-directed signal processing, is used to create, at user demand, a virtualized world, viewable from any location in an area, in any direction of gaze, at any time within an interval of capture. This data stream is transmitted for near-term network-based delivery, and 5G. Finally, that virtualized world, because it is inherently model-based, is integrated with augmentations (or deletions), creating a harmonized and photorealistic mix of real, and synthetic, worlds. This provides a fully immersive, mixed reality world, in which full interactivity, using gestures, is supported.

For example, U.S. Pat. No. 11,196,964 for Merged reality live event management system and method by Cevat Yerli, granted on Dec. 7, 2021, teaches an accurate and flexible merged reality system and method configured to enable remotely viewing and participating in real or virtual events. In the merged reality system, at least one portion of the real or a virtual world may be respectively replicated or streamed into corresponding sub-universes comprised within the virtual world system, wherein some of the sub-universes comprise events that guests may view and interact with from one or more associated guest physical locations. Other virtual elements, such as purely virtual objects or graphical representations of applications and games, can also be included in the virtual world system. The virtual objects comprise logic, virtual data and models that provide self-computing capabilities and autonomous behavior. The system enables guests to virtually visit, interact and make transactions within the event through the virtual world system.

For example, U.S. Pat. No. 11,202,037 for Virtual presence system and method through merged reality by Cevat Yerli, granted on Dec. 14, 2021, teaches a virtual presence merged reality system comprising a server comprising at least one processor and memory including a data store storing a persistent virtual world system comprising one or more virtual replicas of real world elements. The virtual replicas provide self-computing capabilities and autonomous behavior. The persistent virtual world system comprises a virtual replica of a physical location hosting a live event, wherein the persistent virtual world system is configured to communicate through a network with a plurality of connected devices that include sensing mechanisms configured to capture real-world data of the live event that enables updating the persistent virtual world system. The system enables guests to virtually visit, interact and make transactions within the live event through the persistent virtual world system. Computer-implemented methods thereof are also provided.

For example, US Patent Application No. US20200401576 for Interacting with real-world items and corresponding databases through a virtual twin reality by Cevat Yerli, published on Dec. 24, 2021, teaches a system comprising at least one cloud server of a cloud server computer system comprising at least one processor and memory storing a persistent virtual world system comprising one or more virtual objects including virtual data and models. The virtual objects comprise one or more of a virtual twin, a pure virtual object, or an application, wherein at least one of the virtual objects represents a store of real-world items connected to a periodically-updated database associated to the products of the at least one store. Users may access the store through the persistent virtual world system via a user device enabling interactions with and between elements within the store.

For example, U.S. Pat. No. 11,245,872 for Merged reality spatial streaming of virtual spaces by Cevat Yerli, granted on Feb. 8, 2022, teaches a merged reality system comprising at least one server storing a virtual world system comprising one or more virtual objects, the virtual objects including virtual replicas of at least a first location, a second location, and real-world elements in the at least first and second locations. The at least one server is configured to receive, from a plurality of connected devices communicating with the at least one server through a network, real-world data from real-world elements in the first and second locations; use the real-world data from the first and second locations in the virtual world system to enrich and synchronize the virtual replicas with corresponding real-world elements; and overlap and stream at least one portion of the real-world data from the second location onto, e.g., one or more surfaces of the virtual replica of the first location.

For example, U.S. Pat. No. 11,032,588 for Method and apparatus for spatial enhanced adaptive bitrate live streaming for 360 degree video playback by Haritaoglu et al. granted Jun. 8, 2021 for an apparatus and method for delivering a spatially enhanced live streaming experience for virtual reality or 360 degree live streaming of video is disclosed. A live streaming video signal is encoded into multiple streams at varying resolutions. A portion of the high resolution video stream, corresponding to a field of view within the entire 360 degree view, is merged with a low resolution video stream. The resulting video stream is referred to as a spatial adaptive video stream. Multiple spatial adaptive video streams are generated to provide a high resolution field of view across the entire 360 degrees. As the viewer looks in different directions, the video player plays back one of the spatial adaptive video streams according to the direction in which the viewer is looking.

In yet another example, US Patent Publication No. 2020/0082389 for Payment system for augmented, mixed, or virtual reality platforms integrated with cryptocurrency wallet by inventor Regev, filed Sep. 9, 2019 and published Mar. 12, 2020, discloses an improved electronic reality system (e.g., augmented reality, mixed reality, and/or or virtual reality system) that integrates a cryptocurrency wallet for transmitting funds between senders and recipients based on interactions made in the electronic reality system, such as a drag and drop interaction in which an image of an item to be purchased or representation of funds to be transferred is dragged and dropped to an image of the cryptocurrency wallet in an AR display.

Furthermore, companies like Google Inc. and Apple inc. are working on devices that are aimed at enabling users to use virtual and augmented reality applications, for example, Google glasses and Apple Glass, Apple AR/VR Headset, Magic Leap VR. Other companies are also developing various virtual and augmented reality devices for users. These devices have application programming interfaces (APIs) that provide access to developers for generating virtual and augmented reality applications compatible with them.

The inventions heretofore are known to suffer from a number of shortcomings, which include the lack of satisfactory computing power to host data-heady virtual reality environments, insufficient flexibility of data traffic control, as well as those technologies are costly to implement for large scale live events.

What is needed is a method and/or system that solves one or more of the problems described herein and/or one or more problems that may come to the attention of one skilled in the art upon becoming familiar with this specification.

The objective of the present technology is to provide an efficient method and a system for generating interactive virtual or augmented reality environments that correspond to digital twins of real-life elements and/or live events, and effectively integrate these interactive virtual realities environments into metaverses. The method and the system must be more accessible to Internet users, as well as reliable, easily installable, and more cost-effective than existing systems and methods.

Another objective of the present technology is to provide an efficient method and a system for adapting technologies of generating interactive virtual or augmented reality environments to digitalizing live events in real-time with the use of Spatial Web computing. The method and the system must be more accessible to Internet users, as well as reliable, easily installable, and more cost-effective than existing systems and methods.

### SUMMARY

It is thus an object of the present technology to ameliorate at least some of the inconveniences present in the prior art.

The present invention relates to generating graphical representations of physical spaces and/or large scale events from video feeds with the aim of generating a stable digital virtual reality representation thereof, such that a user is able to access the digital virtual reality representation and process sufficient amount of traffic to interact with the digital elements of the environment generated by the digital virtual reality representation.

Embodiments of the present technology have been developed based on researchers' appreciation of at least one technical problem associated with the prior art approaches to generating and maintaining digital virtual or augmented realities. The engineers took into consideration the possibilities of applying distributed ledger technologies, blockchain technologies, and automation technologies related to video gaming environment programming.

For example, the presently known prior art systems do not appear to take into account advancements in modern computing capabilities and security enhancements of blockchain technologies.

The researchers further discovered that it would be beneficial to provide a system that is capable of using several independent server network configurations that are connected to the same network to generate digital representations of spatial environments.

In the context of the present specification, unless specifically provided otherwise, the words “first”, “second”, “third”, etc. when they are grammatically used as adjectives, have been used as adjectives only for the purpose of allowing for distinction between the nouns that they modify from one another, and not for the purpose of describing any particular relationship between those nouns. Thus, for example, it should be understood that, the use of the terms, “first server” or “second server” is not intended to imply any particular function, order, type, chronology, hierarchy or ranking (for example) of/between the server, nor is their use (by itself or in a combination) intended imply that any “first” or “second server” must necessarily exist in any given situation. Further, as is discussed herein in other contexts, reference to a “first” element and a “second” element does not preclude the two elements from being the same actual real-world element. Thus, for example, in some instances, a “first” or a “second” server may be the same software and/or hardware, and in other cases they may be different software and/or hardware.

According to a first broad aspect of the present technology, there is provided a system for generating a digital twin in an interactive virtual or augmented reality environment. The digital twin corresponds to a physical live event, for example, a live performance, a live performance art event, a sports event, a concert, a public event, a private event, etc. The digital twin may also correspond to a portion of a live event, for example, any real-life element of the live event, parameters of which have been recorded and digitalized, which may be the geometry of a concert hall, an event venue, an entertainment venue, an entertainment park, a stadium, an arena, or a performance on an artist, an athlete or a group thereof, parts of an exhibition displayed at the concert hall or a stadium, etc. The system comprises a plurality of video capturing devices connected to a network. Each video capturing device is adapted to operate within a predetermined set of coordinates of the live event. The set of coordinates defines a physical space where the live event is taking place. Each video capturing device is adapted to be remotely controlled. The video capturing devices may be controlled independently from one another or may be controlled as a group of devices. The controlling may be preprogrammed into the system or it may be controlled partly or fully by an operator. Each of the video capturing devices is adapted to capture videos of the live event. It is understood that the video capturing devices may include any devices that are suitable for collecting data that may be digitalized to create a graphical representation for the virtual reality environment, for example, the video capturing devices may be video cameras, infra-red cameras, special (distance) measurement cameras, drones, etc. It is understood to a person skilled in the art that these particular methods may develop and change with developing technologies in the future, while remaining within the scope of the present invention.

For the ease of understanding, the term “video” herein corresponds to any data that may be captured by a video capturing device and that may be used to create a graphical representation for the virtual reality environment.

Continuing with the first broad aspect of the present technology, each captured video has a corresponding metadata. The metadata herein is the data that provides information about other data, but not the content of the data. For example, the corresponding metadata for the video includes other data that may be associated with the video, such as the description of the artist, athlete or the performance that is captured into video, as well as the location of the capturing of the video, the types of devices that capture the video, any encoders or libraries or other data that may be useful for generating a digital twin based on the captured video.

The system also has a plurality of audio recording devices that may be adapted to record one or more audio tracks of the live event, record portions of the live event, for example, music, voice, ambient sounds, etc. The plurality of audio recording devices may be also adapted to record a 3-D audio field of the live event, as well as record different strengths of different audio tracks at different locations of the physical space where the life event is taking place.

The system also has a server, or a plurality of servers configured to receive data from each video capturing device each audio recording device. The server is operating a computing module. The module is configured to analyze the captured videos and the corresponding metadata, which includes but not limited to determining a spatial depth between images being captured by different video capturing devices, matching each captured video to a coordinate matrix of the physical space where the life event is taking place, matching the 3-D audio field to the coordinate matrix of the physical space, generating the digital twin of at least a portion of the live event based on the captured videos, the corresponding metadata, the special depth, the predetermined set of coordinates and the coordinate matrix. The server is configured to generate a plurality of digital representations from multiple directions of the live event, including an at least one 360-degree digital representation and a plurality of unidirectional digital representations, each digital representation corresponding to a viewing angle within the digital twin in the interactive virtual reality environment. The server may use any suitable computing techniques to determine the dimensions of the physical space where the life event is taking place, to determine the shapes present within the physical space where the life event is taking place, as well as the distance between each of these shapes, and to generate a digital twin, which consists of a graphical representation of the physical space where the life event is taking place, the shapes present within the physical space where the life event is taking place, and the distance between each of these shapes. The system is further configured such that the digital representations and the audio are transmitted to a receiving device of a user participating in the interactive virtual reality environment of the live event.

In another aspect of the technology, the system is further configured to receive data from the device of the user to feed this data into the system, whereby the data may correspond to user's interactions with the virtual reality environment, including, for example, data related to user's position, user's movements and user's gaze.

The device many be any wearable device with integrated motion-capturing sensors, artificial intelligence glasses, virtual reality glasses, artificial intelligence earphones for binaural sound, virtual reality headsets, mobile phones, computers, laptops, smartwatches, gaming consoles, and cross-network devices.

It is understood that the user's device is not claimed as part of this patent application and references to the user, the user's device or the data generated by the user's device and sent into the system is not part of the system and are merely mentioned for the easy of understanding without limiting the scope of the claims.

In yet another aspect of the technology, the module is further configured to determine real-life elements suitable for being within the graphical representation of the digital twin in the virtual reality environment. As such, the module is configured to determine which real-life elements that may be present in the captured video to omit from the digital representation and which real-life element to keep as part of the digital representation. The module may use various parameters to determine which real-life elements to digitalize and keep within the digital twin. For example, the module may determine a viewing angle of a user and keep only the real-life elements that are within the line of sight of the user. For example, the module may estimate the computing complexity of digitalizing a real-life element for keeping within the digital twin and in cases where the complexity exceeds a certain threshold, the computing module will omit the real-life element, i.e. it will not be digitalized and will not be added/kept within the digital twin.

In yet another aspect of the technology, the digital representations are transmitted to the device in real-time or a delayed time after the live event. For example, a live event may be digitalized generating a digital twin in a virtual reality environment that may be accessible by users in real-time. Other events may be digitalized generating a digital twin in a virtual reality environment that may be accessed by users after the live event passes, thus the digital twin may be a permanent virtual reality environment that may accessed by users at any time, allowing the users to participate in any portion of the live event they desire.

In yet another aspect of the technology, the digital representations, audio recordings, corresponding metadata and corresponding coordinate matrix data are parsed and stored in a database by the system for at least partial on demand re-distribution. For example, the digital twin in the virtual reality environment may be added to different metaverses that are hosted on independent servers and are run on various protocols. As such, any portion of the digital twin of the live event may be used to generate a virtual reality environment that is accessible by users of one or a plurality of metaverses.

In yet another aspect of the technology, the digital representations, audio recordings, corresponding metadata and corresponding coordinate matrix data are stored in a distributed manner by blockchain technology. It is understood that the digital twins may be stored in either distributed manner or a centralized manner depending on the desired technical characteristics of the virtual reality environment. In some cases, it may be technologically beneficial to store the digital twins in a distributed manner using blockchain technology with the aim to allow the decentralized use of resources to increase computing power of generating and running virtual reality environments of the digital twins of live events. For example, this may be beneficial for allowing users to access the virtual reality environments of digital twins of live events in real-time.

In yet another aspect of the technology, non-fungible tokens are assigned to at least a portion of the digital twin, including the digital representations, audio recordings, corresponding metadata and corresponding coordinate matrix data. For example, a first non-fungible token may be assigned to a first audio recording, a second non-fungible token may be assigned to a second audio recording, a third non-fungible token may be assigned to a third audio recording, a fourth non-fungible token may be assigned to a first video, a fourth non-fungible token may be assigned to a second video, a fifth non-fungible token may be assigned to a first metadata, a sixth non-fungible token may be assigned to a first set of coordinate matrix data, etc. The non-fungible tokens may be commonly abbreviated as NFTs.

It is understood that in some implementations it is possible that also fungible tokens may be used by the system as a payment instrument, an exchange instrument, or a communications instrument amongst the users or amongst the system and the users.

In yet another aspect of the technology, the system includes a payment processor adapted for identifying a non-fungible token purchased by the user and assigning corresponding non-fungible tokens rights to the user. For example, the payment processor may be integrated in the system, or a third-party payment processor may communicate with the system via a network. It is understood that the term “payment processor” is used herein in the broadest possible sense and includes any technologies that operate with monetary instruments and with non-monetary instruments, such as cryptocurrencies, digital coupons, discount cards, points and the like. It is understood that a purchase of a non-fungible token (NFT) is understood herein as it would be understood my any person skilled in the art of using non-fungible tokens, as such unique rights may be associated with the NFT and these rights may transferred to a purchaser thereof by any suitable computing protocol, including any suitable blockchain protocol.

In yet another aspect of the technology, the system assigns a non-fungible token to the digital twin of the live event. For example, it is possible to assign the rights to the entire digital twin, such that the owner of the NFT of the entire digital twin may control the assignment of further sub rights to the portions of the digital twin. For example, it is possible to assign the rights to the entire digital twin, such that the owner of the NFT of the entire digital twin may control the assignment of further sub rights to the portions of the digital twin to multiple users, otherwise known as fractionalized ownership.

In yet another aspect of the technology, the system uses artificial intelligence to generate graphical representations. For example, the artificial intelligence algorithms may be used to determine how to approximate the digitalizing of shapes and dimensions of real-life elements in order to generate digital twins thereof prior to assembling a full digital twin of the live event. For example, the artificial intelligence may approximate the shape of a stage, the figure of a performer, the size of a stadium, the dimensions of athletes, the seats for spectators, the dance floor, the mash pit, the crowd, a restaurant area with tables and chairs, walls, windows, balconies, musical instruments, sporting equipment, etc.

In yet another aspect of the technology, the system generates data streams that are received by user devices, the data streams command the user device to generate an augmented reality effect for the user, which include (a) a graphical projection onto a physical element or as a hologram and an audio stream, of at least a portion of a digital twin of the live event or the real-life element, (b) graphical representations and an audio stream by the user device for the user of at least a portion of the digital twin of the live event or the real-life element, or (c) a combination of (a) and (b) described herein. Whereby the generated augmented reality effect for the user enables the user devices to deliver to the user an experience of the physical location that is digitalized into the digital twin augmented reality environment.

According to a second broad aspect of the present technology, there is provided a method for generating an interactive virtual reality environment in a metaverse. The environment includes multiple digital twins of real-life elements that have been digitalized into graphical representations. The multiple digital twins may consist of at least one of a visual element, an audio element, a spatial element, and a tactitional element. For example, a visual element is a graphical representation of a captured video, i.e. after the captured video was processed and digitalized into a suitable file format that may be integrated into a metaverse. For instance, it may be a videogame like graphical representation, or it may be computer generated virtual reality like graphical representation. The visual element is the graphical representation that a user may see via its user device through the eyes of his/her avatar, as the avatar observes the metaverse from different angles of view. An audio element may be, for example, an audio track that a user hears via its user device. A spatial element may be, for example, any computer code that allows the user's avatar to determine a distance that the avatar has to travel in the virtual reality environment in the metaverse form one location or another, or a direction that the avatar may look at, or throw an object into, or hear a sound from, etc. A tactitial element may be, for example, computer code that aims to generate a command to the user's device to simulate a tacit sensation that a user may feel via the user's device interface while interacting with the metaverse. The tacit sensation may be, for example, a vibration, a push, an electric pulse, a temperature difference, etc. The tactitial element may be generated by mechanisms integrated into the user's device and controlled by the system by sending commands to the device to engage the user, for example, if a user is touching a vibrating object in the metaverse, the users device may vibrate accordingly, etc. The virtual reality environment of the digital twin may be connected to a distributed ledger technology for ease of performing complex computing operations, and/or for ease communication between user devices and the metaverse hosting servers. The method comprises the following steps:
(i) generating a digital twin of the real-life element by executing:
   (a) a capturing a video and generating the visual element, which is its corresponding digital representation, recording an audio and generating the audio element, which is its corresponding digital audio element, determining tactitional characteristics of an object within the digital twin and generating the tactitional element, and measuring a distance and spatial coordinates between shapes and/or spaces in the virtual reality environment of the digital twin and generating the spatial element, and
   (b) recording a corresponding metadata to one of the visual element, the audio element, the spatial element, and the tactitional element;
(ii) storing the digital twin in a server;
(iii) assigning tokens to at least one of the video element, the audio element, the spatial element, and the tactitional element;
(iv) connecting the server to a metaverse hosting server;
(v) integrating the digital twin into the metaverse by generating the virtual reality environment corresponding to the digital twin;
(vi) providing access to the virtual reality environment to a user device for interactive experience within the virtual reality environment by allowing the user to interact with the at least one of the visual element, the audio element, the spatial element, and the tactitional element.

In another aspect of the technology, the step of storing the digital twin on a server further includes storing the digital twin in a distributed manner by blockchain technology.

In yet another aspect of the technology, the method further includes communicating token data with a user device. For example, the token data may be used for interacting and/or managing rights by the user with the at least one of the visual element, the audio element, the spatial element, and the tactitional element.

In yet another aspect of the technology, the token is a non-fungible token.

In yet another aspect of the technology, the step of providing access to the virtual reality environment a user's device includes receiving commands from a user's wearable device with integrated motion-capturing sensors, artificial intelligence glasses, virtual reality glasses, artificial intelligence earphones for binaural sound, virtual reality headsets, mobile phones, computers, laptops, smartwatches, gaming consoles, and cross-network devices by the metaverse hosting server or by the preprogrammed server.

In yet another aspect of the technology, the step of measuring distance and spatial coordinates includes determining at least one of a shape of the visual element, a distance a first visual element and a second visual element, and a velocity associated a moving visual element.

In yet another aspect of the technology, further includes connecting a payment processor adapted for identifying a purchased token and corresponding rights of the purchased token.

In yet another aspect of the technology, the step of the providing access to the virtual reality environment includes allowing the user to launch its digital self to any location within virtual reality environment.

In yet another aspect of the technology, the method further includes generating a portion of the metaverse based on the virtual reality environment of the digital twin.

In yet another aspect of the technology, the method further includes generating multiple virtual reality environments corresponding to multiple digital twins.

In yet another aspect of the technology, the method further includes integrating multiple digital twins into the virtual reality environments.

In yet another aspect of the technology, the method further includes selecting real-life elements for digitalization within the digital twin. For example, this step includes determining which real-life elements will be digitalized and added as digital elements within the virtual reality environment, and which elements that are part of the captured video, recorded audio, measured spatial data, measured tactitinal data are omitted from the digital twin, and/or deleted from the final virtual reality environment that is generated within a metaverse. In another embodiment, the selecting of real-life elements includes generating an approximation of the real-life element, which is represented as a visual element, an audio element, a tactitional element, a spatial element, or a combination thereof. The approximation may be rough or may be detailed depending of the desired characteristics of the virtual reality environment.

According to a third broad aspect of the present technology, there is provided a method operated by a system for generating a 3-d graphical representation in a virtual reality environment. The 3-d graphical representation corresponds to a real-life element or a live event. The system is connected to a network. The system includes a video capturing device, a corresponding metadata recording device, an audio recording device, a server configured to receive data from the video capturing device, audio recording device, the metadata recording device. The server operates a computing module configured to analyze the captured videos, recorded audio and recorded corresponding metadata, as well as to digitalize objects shown in the images of the captured video and identified at least partly by the corresponding metadata to create the 3-d graphical representation of the real-life element or live event. The method comprises the following steps:
a. generating a 3-d graphical representation model based on objects shown in the images of the captured video, based on determining distances between the objects shown in the images of the captured video, and based on analyzed corresponding metadata;
b. linking audio tracks to elements in the 3-d graphical representation;
c. storing the 3-d graphical representation on the server;
d. connecting the server to a metaverse hosting server;
e. integrating the 3-d graphical representation into the metaverse by generating the virtual reality environment corresponding to the 3-d graphical representation;
f. providing access to the virtual reality environment to a user's device.

The method may also generate a coordinate matrix of a physical space corresponding to the real-life elements, and to generate the 3-d graphical representation of at least a portion of the real-life elements.

The method may also determine tactitional characteristics of objects shown in the images of the captured video and assign these characteristics to the 3-d graphical representation for future interactions with a user's device or user's avatar.

The method may also determine spatial coordinates of the 3-d graphical representation and assign these coordinates to the objects shown in the images of the captured video.

The method may also enable interactive experience within the virtual reality environment by allowing the user to interact with the digital twins of the objects shown in the images of the captured video.

According to a fourth broad aspect of the present technology, there is provided a system for generating a digital twin in an interactive virtual reality environment, the digital twin corresponding to at least one real-life element. The system is connected to a network. The system comprises a video capturing device, a corresponding metadata recording device, an audio recording device, a server configured to receive data from the video capturing device, audio recording device, the metadata recording device. The server operates a computing module configured (a) to analyze the captured videos, recorded audio and recorded corresponding metadata, (b) to determine shapes of objects in the captured videos and distances between objects in the captures videos, (c) to determine a coordinate matrix of 3-d virtual space containing digital twins of the real-life elements.

According to a fifth broad aspect of the present technology, there is provided a system for integrating an interactive virtual reality environment corresponding to a digital twin of a real-life element. The system is connected to a network. The system comprises a video capturing device, a corresponding metadata recording device, an audio recording device, a server configured to receive data from the video capturing device, audio recording device, the metadata recording device. The server operates a computing module configured (a) to analyze the captured videos, recorded audio and recorded corresponding metadata, to determine a spatial depth between real-life elements captured by video capturing devices, recorded by audio devices or recorded by metadata devices, (b) to approximate shapes of real-life elements, (c) to determine real-life elements suitable for digitalization, and (d) to generate the digital twin of at least a portion of the life-elements. The server is configured to send data to a metaverse hosting server for integrating the interactive virtual reality environment into the metaverse.

According to a sixth broad aspect of the present technology, there is provided a system for generating computational spaces integrating augmented reality, mixed reality, virtual reality, geofencing, cryptocurrency, and other technologies to provide a segmented database of a digitized space mimicking, dedicated to, and catered for live music events, live performance arts, and all events classified as live sporting events.

In another embodiment of the present technology, there is provided a system and a method for providing a shared virtual or augmented reality environment, enabling digital overlay skins on a user's avatar to be viewed by other participants in the shared virtual or augmented reality environment.

In yet another embodiment of the technology, there is provided a system and a method for informing participants in an augmented or virtual reality environment of upcoming related events for music, live entertainment, and sporting events, including dynamic pop-ups and/or advertisements.

In yet another embodiment of the technology, there is provided a system and a method for integrating into the digital twin an application programming interface that allows communication via protocols that are compatible with “Play To Earn Gaming Framework” integrated in metaverses.

In yet another embodiment of the technology, there is provided a system and a method allowing participants to make purchases of event-related memorabilia, event tickets, or other items in an augmented or virtual reality environment including dynamic pop-ups and/or advertisements.

In yet another aspect of the technology, the metaverse event may differ from that of the live event corresponding to the digital twin. The virtual or augmented reality immersive event may be hosted in multiple virtual or augmented reality environments in addition to the virtual or augmented reality environment of live event venue that is recorded, digitalized and broadcasted as the main digital twin of the live event. For example, the digital metaverse event space may have a secondary virtual or augmented reality environment generated by the system 100 that may be represented in the metaverse as another room or another venue, where virtual objects related and/or unrelated to principal live event may be presented. For instance, these virtual objects may include digital NFT art galleries that are generated by the methods described herein, whereby these digital NFT art galleries offset of the original venue metaverse that is corresponding to the digital twin of the live event virtual or augmented reality environment.

In yet another aspect of the technology, the present technology includes an augmented reality environment configured to interact with the real-live physical environment, such as buildings, city spaces, parks, rooms, stadiums, etc. The augmented reality environment operates on a server that have a computer processor and a database. The server is connected to a network such that the augmented reality environment is enabled to communicate with a plurality of user devices (e.g., smart phones, computers, AR/VR headsets, etc.). The augmented reality environment may communicate with the user devices by any suitable computer program and/or a mobile application. The user device is configured to display what is captured by a camera of the user device, with at least one digital overlay added to the image by the augmented reality environment. In one embodiment, the camera and/or a LiDAR system associated with the user device is operable to generate a point cloud mapping a space. The point cloud provides the system not only with an image of the environment, but a range of depths and relative angles of objects in the environment as well to map the environment in three-dimensional space. Methods of generating a LiDAR point cloud are described in US Patent Publication Nos. 2020/0158869 and 2019/0244378, each of which is incorporated herein by reference in its entirety.

In yet another aspect of the technology, the virtual or augmented reality environment is configured to record the profiles of users interacting therewith. Each user profile has its own user associated data, for example, preferences, age, sex, associated digital wallet that is configured to store one or more cryptocurrencies and/or information regarding one or more fiat currencies, etc.

In yet another aspect of the technology, the virtual or augmented reality environment is associated with a predetermined cryptocurrency that is configured to be used to purchase goods within the virtual or augmented reality environment, pay for events within the environment, bet on events and/or games within the environment, and/or be used to access certain areas within the environment. For example, the cryptocurrency may be a cryptocurrency that is native to the virtual or augmented reality environment and/or the metaverse, and is only operable to be exchanged within the virtual or augmented reality environment. In one embodiment, the area in which the cryptocurrency may be used is defined by at least one geofence.

In yet another aspect of the technology, different areas of the virtual or augmented reality environment are marked with unique identifiers, for example, ID numbers, cryptocurrency tokens, QR codes, barcodes, etc. For example, the identifiers may be images, sounds, a three-dimensional objects, point cloud representations, etc.

It is understood that the data within or associated with virtual or augmented reality environment stored in centralized or distributed databases on servers hosting the virtual or augmented reality environment. Every virtual object within the virtual or augmented reality environment is indexed by a unique identifier. In some embodiments, the unique identifier may be associated with a relative light level, elevation, location coloration, location purpose (e.g., game room, store, hallway, etc.) and/or information regarding its relative position compared to other unique identifies. Information associated with the unique identifier is used to determine what digital overlays to provide over those unique identifiers.

In yet another aspect of the technology, the virtual or augmented reality environment enables the selection of a geolocation as a destination. When a geolocation is selected, the the virtual or augmented reality environment automatically determines a point of origin of selection (e.g., where a user is located when the destination geolocation is selected) through collection of sensor data from at least one geolocation sensor in a user device making the selection. In another embodiment, the point of origin of selection is determined through received signal strength indication (RSSI) between the user device and a plurality of beacons (e.g., based on WI-FI, BLUETOOTH, WIMAX, etc.) through methods known in the art, such as in US Patent Publication No. 2017/0295461, which is incorporated herein by reference in its entirety. Using the selected destination geolocation and the determined origin geolocation, the augmented reality platform automatically generates an optimal route (e.g., shortest path taking into account traffic) between the two locations using any method used in the art, such as that described in U.S. Pat. No. 9,886,036, which is incorporated herein by reference in its entirety.

In yet another aspect of the technology, uses the geofence technology. Geofences described herein are generated as described in the prior art, such as U.S. Pat. Nos. 10,375,514, 10,841,734, 10,834,212, and 10,979,849, each of which is incorporated herein by reference in its entirety.

In yet another aspect of the technology, the virtual or augmented reality environment recognizes other users based on facial recognition of the user, using any facial recognition technique known in the art, such as that described in U.S. Pat. No. 9,275,269, which is incorporated herein by reference in its entirety.

The virtual or augmented reality environment operates on a computer system connected to a network, having a plurality of computing devices, a server, and a database. The server is configured to communicate over the network with a plurality of computing devices The server typically includes a processing unit with an operating system as is known in the art. The operating system executes computer programs to generate and operationally maintain the virtual or augmented reality environment. A database is typically used to store data required to operate the operating system, a memory, and programs required to generate and maintain the virtual or augmented reality environment.

In the context of the present specification, unless specifically provided otherwise, a “server” is a computer program that is running on appropriate hardware and is capable of receiving requests (e.g. from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task has been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless specifically provided otherwise, a “module” is a computer program that is running on appropriate hardware and is capable of carrying some computational tasks or causing those tasks to be carried out. The term “module” is meant to have a broader technological meaning than “server” and is not tied to any hardware whatsoever. The term “module” may mean one or more modules and is not limited to any combination of modules or hardware used therewith.

In the context of the present specification, unless specifically provided otherwise, a “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a user device in the present context is not precluded from acting as a server or a module to other devices. The use of the expression “a device” does not preclude multiple devices being used in receiving/sending, carrying out or causing to be carried out any task or request, or the consequences of any task or request, or steps of any method described herein.

In the context of the present specification, unless specifically provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless specifically provided otherwise, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, etc.

In the context of the present specification, unless specifically provided otherwise, the expression “component” is meant to include software (appropriate to a particular hardware context) that is both necessary and sufficient to achieve the specific function(s) being referenced.

In the context of the present specification, unless specifically provided otherwise, the expression “digital representation” and “graphical representation” are used interchangeably.

In the context of the present specification, unless specifically provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

Implementations of the present technology each have at least one of the abovementioned object and/or aspects, but do not necessarily have all of them. It should be understood that some aspects of the present technology that have resulted from attempting to attain the abovementioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system in communication with a metaverse and user devices implemented in accordance with an embodiment of the present technology;

FIG. 2 is a schematic diagram of an alternative implementation of the system in communication with user devices in accordance with an embodiment of the present technology;

FIG. 3 is a schematic diagram of another alternative implementation of the system in communication with user devices in accordance with an embodiment of the present technology;

FIG. 4 is a schematic diagram of another alternative implementation of the system in communication with user devices in accordance with an embodiment of the present technology;

FIG. 5, there is depicted a block diagram of another alternative method implemented in accordance with an embodiment of the present technology;

FIG. 6, there is depicted block diagram of another alternative method implemented in accordance with an embodiment of the present technology;

FIG. 7, there is depicted a block diagram of another alternative method implemented in accordance with an embodiment of the present technology;

FIG. 8, there is depicted a block diagram of a method of generating a 3-D digital twin implemented in accordance with an embodiment of the present technology;

FIG. 9, there is depicted a block diagram of another method of generating a 3-D digital twin implemented in accordance with an embodiment of the present technology;

FIG. 10, there is depicted a block diagram of another method of generating a 3-D digital twin implemented in accordance with an embodiment of the present technology;

FIG. 11, there is depicted a block diagram of method user interactions with a virtual reality environment implemented in accordance with an embodiment of the present technology;

FIG. 12 is a schematic diagram of a user device implemented in accordance with an embodiment of the present technology.

### DETAILED DESCRIPTION

Reference will now be made in detail to some specific examples of the embodiments of the invention including some modes of carrying out the invention that are contemplated by the inventors to be suitable for understanding the technology. Examples of the specific embodiments are illustrated in the accompanying drawings. While the technology is described in conjunction with these specific embodiments, it will be understood that it is not intended to limit the invention to the described embodiments. On the contrary, it is intended to cover alternatives, modifications, and equivalents as may be included within the scope of the invention as defined by the appended claims.

The techniques and mechanisms of the present technology may be described in the context of the present technology. However, it should be noted that the techniques and mechanisms of the present technology apply to a variety of modality combinations, and not just the outlined examples and embodiments. In the following description, specific details are set forth in order to provide a thorough understanding of the present technology. Particular example embodiments of the present technology may be implemented without some or all of these specific details. In other instances, well known process operations have not been described in detail in order not to unnecessarily obscure the present technology.

The current disclosure describes flexible virtual and augmented reality systems and methods configured to enable remotely generating fully immersive virtual reality environments and party immersive augmented reality environments that a user may choose to view and/or participate in. The virtual and augmented reality system is generated by merging digitalization of real-life elements and spaces, as well as generating artificial objects within the realty environment itself. At least one portion of the real or a virtual world may be respectively replicated or streamed into corresponding spaces of metaverses creating sub-universes and/or sub-paces of a larger virtual world. The sub-universes and/or sub-spaces may be adapted to hosting digital twins of live events that users may view and/or interact with from one or more associated user physical locations. Virtual elements, which are purely virtual objects and graphical representations of applications, games and characters, may be generated by the system or may be generated by third-party resources with access to the virtual world via a network.

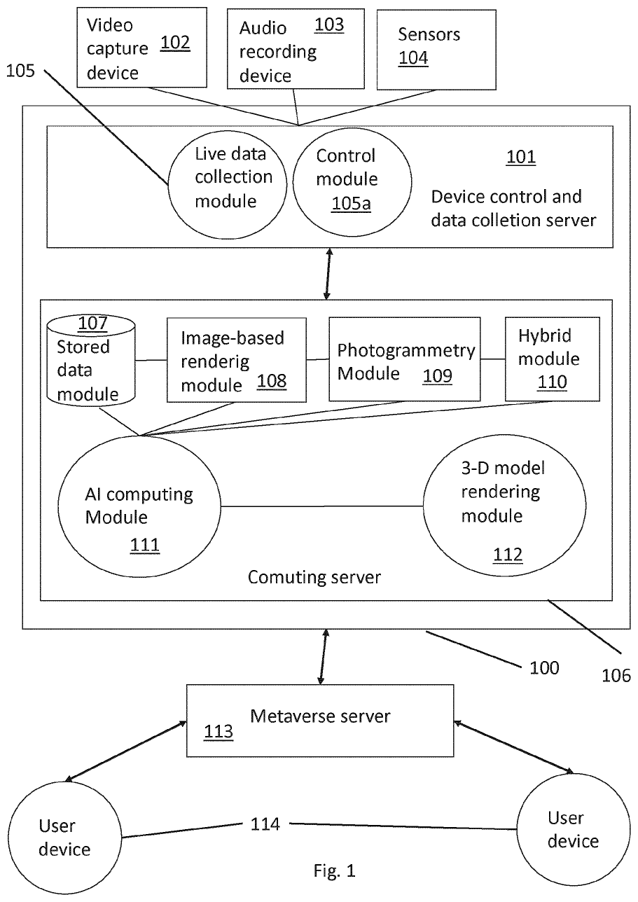

FIG. 1 shows an exemplary embodiment of a system 100. The system 100 is configured to generate digital twins of real-life elements and/or life events, digitalize them in real-time, creating interactive 3D digital representations, which are assembled into 3D models that may be integrated into metaverses and/or sub-universes or virtual spaces as virtual or augmented reality environments. The system 100 may be hosted on a single server or a combination of servers. In the present embodiment, system 100 has a device control and data collection server 101 and a computing server 106. It is understood by a person skilled in the art that the servers 101 and 106 may each be a plurality of servers and/or a cloud-based computing configuration hosting multiple modules described in more detailed hereinbelow, and/or a blockchain technology configuration hosted on a distributed ledger, which is configured for running the multiple modules described in more detailed hereinbelow.

The system 100 is connected to a network, for example the Internet, for wireless or wired communication and for processing by at least one mobile communication computing device. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. The system 100 may be a virtualized computing system capable of executing any or all aspects of software and/or application components presented herein on the device control and data collection server 101 and the computing server 106. In certain aspects, the computer system 100 is operable to be implemented using hardware or a combination of software and hardware, either in a dedicated computing device, or integrated into another entity, or distributed across multiple entities or computing devices.

The device control and data collection server 101 and the computing server 106 may be any suitable electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application. For example, the device control and data collection server 101 and/or the computing server 106 includes components such as a processor, a system memory having a random access memory (RAM) and a read-only memory (ROM), and a system bus that couples the memory to the processor (not shown). The device control and data collection server 101 and the computing server 106 may be configured to include components such as a storage device for storing an operating system and one or more application programs, a network interface unit, and/or an input/output controller (not shown). Each of the components is operable to be coupled to each other through at least one bus. The input/output controller is operable to receive and process input from, or provide output to, a number of other devices, including, but not limited to, alphanumeric input devices, mice, electronic styluses, display units, touch screens, signal generation devices (e.g., speakers), or printers. The processor may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

It is understood that there may be multiple processors, multiple buses, multiple memories of multiple types (e.g., a combination of a DSP and a microprocessor, a plurality of microprocessors, one or more microprocessors in conjunction with a DSP core). Multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

The system 100 generates instructions that are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory, the processor, and/or the storage media and is operable be a single medium or multiple media (e.g., a centralized or distributed computer system) that store the one or more sets of instructions. Non-transitory computer readable media includes all computer readable media, with the sole exception being a transitory, propagating signal per se. The instructions may be transmitted or received over the network via the network interface unit, which is operable to include a modulated data signal such as a carrier wave or other transport mechanism and includes any delivery media. The term “modulated data signal” means a signal that has one or more of its characteristics changed or set in a manner as to encode information in the signal.

Storage devices and memory include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the system 100.

The device control and data collection server 101 has live data collection module 105 and a control module 105a. It is understood that the data collection module 105 may be on one device control and data collection server 101 and the control module 105a may be on another device control and data collection server 101.

The control module 105a is controls a plurality of video capture deices 102, a plurality of audio recording devices 103 and a plurality of sensors 104. It is understood there may be any number of video capture devices 102, audio capture devices 103 and sensors 104, i.e. from one to a few hundreds. The amount of the video capture devices 102, audio capture devices 103 and sensors 104 depends on the physical space and/or real-life element that needs to be captured and digitalized. Sometimes a single video capture device 102, a single audio capture devices 103 and a single sensor 104 will suffice. Other times a single or several video capture devices 102 without any other devices will suffice. Other times a single or several audio capture devices 103 without any other devices will suffice. Permutations of video capture devices 102, audio capture devices 103 and sensors 104 depends on the amount of data streams that may be needed to digitalize a live event or a real-life element. The video capture devices 102 include all types of cameras, for example, video cameras, infrared cameras, ultra-violet cameras, etc. Audio capture devices 103 include devices that record all types of sounds that may be used to map spaces and/or that are generated at a live event. The sensors 104 include motion sensors, locations sensors, proximity sensors, thermos sensors, accelerometers, etc. The sensors 104 are typically used as auxiliary data stream sources that may be helpful in identifying types of objects, shapes and distances and coordinates of a physical space where the live event is taking place, as well as position and movements performers, athletes, decorations, equipment, etc., and also luminosity, texture, temperature and other properties of objects that are digitalized for including into the 3D model of the virtual or augmented reality environment.

The video capture devices 102, the audio recording devices 103 and the sensors 104 are controlled remotely by the control module 105a. Typically, each of the video capture devices 102, the audio recording devices 103 and the sensors 104 has a predetermined position at the physical space where the live event is taking place, has known coordinates within the physical space, has known recording ranges, has known angles of recording (for example: angles of view), has known sensitivity, has known range of movement, etc. These known parameters are coined herein as corresponding metadata. As such, each of the video capture devices 102, the audio recording devices 103 and the sensors 104 has a corresponding metadata that corresponds to that particular device. Each of the video capture devices 102, the audio recording devices 103 and the sensors 104 is calibrated for each live event and such calibration parameters is also part of the metadata.

The live data collection module 105 of the device control and data collection server 101 is configured to receive data streams from the video capture devices 102, the audio recording devices 103 and the sensors 104 during the recording of a live event. In some embodiments of the present technology, different configurations of these devices may be arranged to record data of a live event. For example, the video capture devices 102 may be integrated with the audio recording devices 103 and the sensors 104. As such, it may be a single device such as a smart phone, a video camera or a drone that records video, audio, location, movement, acceleration, etc. In other configurations, there may be a video camera that records video and audio, but its location and its movements within the physical space of the live event venue may be measured by a separate sensor 104, which may be located on a tripod or a drone or otherwise attached to the device moving the camera. In other configurations, the video camera movements may be prerecorded, and the video camera will move along a certain trajectory. In other configurations, the audio may be recorded by audio recording devices 103 that are independent from the video capture devices 102 and the sensors 104, for example, such an audio recording device 103 may be a microphone attached to a performer of the live event. It is understood that there may be as many audio recording devices 103, such as microphones as there are sources of sound, for example, instruments, performers, audience, etc.

A person skilled it the art of will understand that any number of configurations of video capture devices 102, audio recording devices 103 and sensors 104 are possible and those configurations are within the scope of the present technology. It is understood that regardless of such configurations, the live data collection module collects a sufficient number of data streams, which may include captured video, recorded audio and sensor data (luminosity, movements, location, acceleration, temperature, etc.) to generate a 3D model of the physical space of the live event venue, and/or of the performers/athletes/audience/staff participating in the live event.

The live data collection module 105 receives all data streams in digital formats that are suitable for processing by the system 100. The data streams are stored into the live data collection module 105 after being indexed in accordance with the system 100. Each individual data stream is identified by all necessary information that a person known in the art would estimate, for example: file type, file size, information about the device that recorded the data, corresponding metadata, etc. The information for identifying the data streams will depends on computer model used by the computing server 106 to analyze the data streams and create a 3D model of the live event physical space with real-life elements integrated into the 3D model for creating the digital twin for the virtual or augmented reality environment.

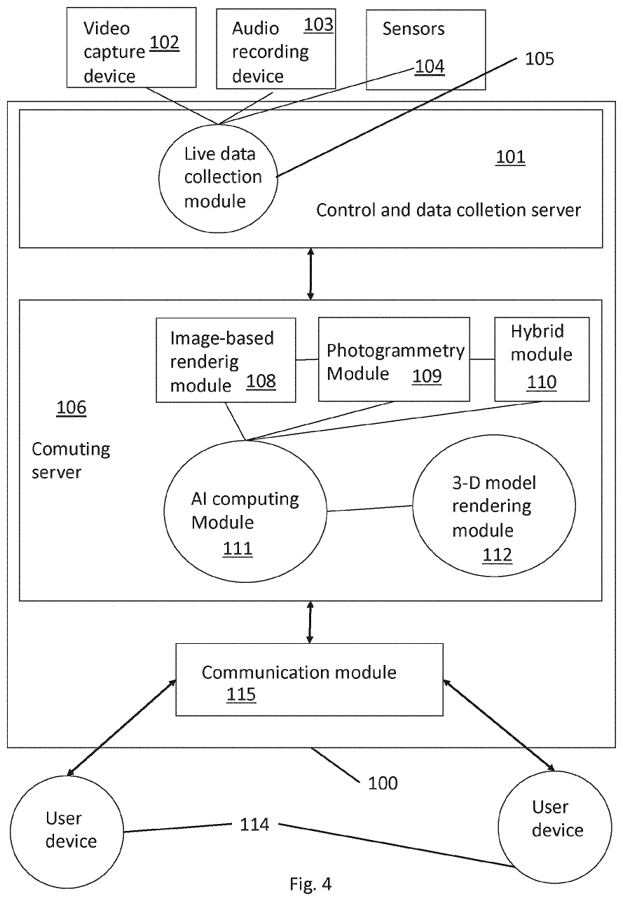

The computing server 106 receives data from the device control and data collection server 101. The computing server 106 may processes the received data by two approaches:
(a) the computing server 106 will supplement the data received from the live data collection module 105 by data/information that is located in the stored data module 107 as shown in FIGS. 1, 2 and 3, and the computing server 106 will apply one or more techniques to the data of live data collection module 105 supplemented by the data stored in the stored data module 107, for generating a 3D model and the digital twin of the live event; or
(b) the computing server 106 will not supplement the data received from the live data collection module 105 by information that is located in the stored data module 107 as shown in FIG. 4, and the computing server 106 will apply one or more techniques for generating a 3D model and the digital twin of the live event only to the data received from the live data collection module 105.

The techniques for generating a 3D model and the digital twin of the live event include at least one of the following:

(a) Image-Based Modeling and Rendering Techniques (IBMR), which may be computed on the Image-based rendering module 108, methods of which are described in Manuel M. Oliveira. Image-Based Modeling and Rendering Techniques: A Survey. Instituto de Informática, UFRGS, Caixa Postal 15064, CEP 91501-970, Porto Alegre, RS, Brasil; Heung-Yeung Shum and Sing Bing Kang. A Review of Image-based Rendering Techniques. Microsoft Research, each of which is incorporated herein by reference in its entirety;

(b) Photogrammetry and close-range photogrammetry techniques, which may be computed on the photogrammetry module 109, methods of which are described in T Luhmann, S Robson, S Kyle and I Harley. Close Range Photogrammetry. Principles, techniques and applications. Published by Whittles Publishing, Dunbeath Mains Cottages, Dunbeath, Caithness KW6 6EY, Scotland, UK, 2006, ISBN 1-870325-50-8; Surendra Pal Singh, Kamal Jain, V. Ravibabu Mandla. A new approach towards image based virtual 3d city modeling by using close range photogrammetry. Geomatics Engineering Section, Department of Civil Engineering, Indian Institute of Technology, Roorkee, each of which is incorporated herein by reference in its entirety;

(c) Hybrid techniques, which include such techniques as: Multi-View 3D Reconstruction Technology Based on SFM, combinations of IBMR and close-range photogrammetry, laser scanning technologies, computer vision techniques, etc, which may be computed on the hybrid module 110, method of which are described at least partly in the following documents, that each of which is is incorporated herein by reference in its entirety:
a. Lei Gao, Yingbao Zhao, Jingchang Han and Huixian Liu. Research on Multi-View 3D Reconstruction Technology Based on SFM. School of Electrical Engineering, Hebei University of Science and Technology, Shijiazhuang 050018, China;
b. Shen, X. L.; Dou, Y.; Mills, S.; Eyers, D. M.; Feng, H.; Huang, Z. “Distributed sparse bundle adjustment algorithm based on three-dimension al point partition and asynchronous communication”. Front. Inf. Technol. Electron. Eng. 2018, 19, 889-904;
c. Crosilla, F.; Beinat, A.; Fusiello, A.; Maset, E.; Visintini, D. Basics of computer vision. In Advanced Procrustes Analysis Models in Photogrammetric Computer Vision; Springer International Publishing: Cham, Switzerland, 2019;
d. DeTone, D.; Malisiewicz, T.; Rabinovich, A. Superpoint: Self-supervised interest point detection and description. In Proceedings of the IEEE Conference on Computer Vision and Pattern Recognition Workshops, Salt Lake City, UT, USA, 18-23 Jun. 2018; pp. 224-236;
e. Zhu, S.; Shen, T.; Zhou, L.; Zhang, R.; Wang, J.; Fang, T.; Quan, L. Parallel structure from motion from local increment to global averaging. arXiv 2017, arXiv: 1702.08601;
f. Schonberger, J. L.; Hardmeicr, H.; Sattler, T.; Pollefeys, M. Comparative evaluation of hand-crafted and learned local features. In Proceedings of the IEEE Conference on Computer Vision and Pattern Recognition, Honolulu, HI, USA, 21-26 Jul. 2017; pp. 1482-1491;
g. Bian, J. W.; Lin, W. Y.; Matsushita, Y.; Yeung, S. K. ; Nguyen, T. D.; Cheng, M. M. GMS: Grid-based motion statistics for fast, ultra-robust feature correspondence. In Proceedings of the IEEE Conference on Computer Vision and Pattern Recognition, Honolulu, HI, USA, 21-26 Jul. 2017; pp. 4181-4190;
h. Sweeney, C.; Sattler, T.; Hollerer, T.; Turk, M.; Pollefeys, M. Optimizing the viewing graph for structure-frommotion. In Proceedings of the IEEE International Conference on Computer Vision, Santiago, Chile, 7-13 Dec. 2015;
i. Wilson, K.; Snavely, N. Robust global ranslations with 1dsfm. In European Conference on Computer Vision; Springer: Cham, Switzerland, 2014;
j. Sweeney, C.; Fragoso, V.; Hollerer, T.; Turk, M. Large scale SfM with the distributed camera model. In Proceedings of the 2016 4th International Conference on 3D Vision (3DV), Stanford, CA, USA, 25-28 Oct. 2016; pp. 230-238;
k. Schönberger, J. L.; Frahm, J. M. Structure-from-motion revisited. In Proceedings of the IEEE Conference on Computer Vision and Pattern Recognition, Las Vegas, NV, USA, 27-30 Jun. 2016;
l. Yao, Y.; Luo, Z.; Li, S.; Fang, T.; Quan, L. Mvsnet: Depth inference for unstructured multi-view stereo. In Proceedings of the European Conference on Computer Vision (ECCV), Munich, Germany, 8-14 Sep. 2018; pp. 767-783;
m. Knapitsch, A.; Park, J.; Zhou, Q. Y.; Koltun, V. Tanks and temples: Benchmarking large-scale scene reconstruction. ACM Trans. Graph. 2017, 36, 78-90;
n. Berger, M.; Tagliasacchi, A.; Seversky, L. M. A survey of surface reconstruction from point clouds. Comput. Graph. Forum 2017, 36, 301-329;
o. Zhu, S.; Zhang, R.; Zhou, L.; Shen, T.; Fang, T.; Tan, P.; Quan, L. Very large-scale global SfM by distributed motion averaging. In Proceedings of the IEEE Conference on Computer Vision and Pattern Recognition Workshops, Salt Lake City, UT, USA, 18-23 Jun. 2018;
p. Kasten, Y.; Geifman, A.; Galun, M.; Basri, R. GPSFM: Global projective sfm using algebraic constraints on multi-view fundamental matrices. In Proceedings of the IEEE Computer Society Conference on Computer Vision and Pattern Recognition, Long Beach, CA, USA, 15-20 Jun. 2019;
q. Liu, H.; Zhang, G.; Bao, H. Robust keyframe-based monocular SLAM for augmented reality. In Proceedings of the 2016 IEEE International Symposium on Mixed and Augmented Reality, ISMAR Adjunct 2016, Merida, Mexico, 19-23 Sep. 2016;
r. Ke, T.; Roumeliotis, S. I. An efficient algebraic solution to the perspective-three-point problem. In Proceedings of the IEEE Conference on Computer Vision and Pattern Recognition, Honolulu, HI, USA, 21-26 Jul. 2017; pp. 7225-7233;
S. Cefalu, A.; Haala, N.; Fritsch, D. Hierarchical structure from motion combining global image orientation and structureless bundle adjustment. Int. Arch. Photogramm. Remote Sens. Spat. Inf. Sci. 2017, 42, 535-542;
t. Wang, R.; Lin, J.; Li, L.; Xiao, Z.; Hui, Y.; Xin, Y. A revised orientation-based correction method for SfM-MVS point clouds of outcrops using ground control planes with marks. J. Struct. Geol. 2021, 143, 104266;
u. Dugan, U.; Sangsoo, L. Microscopic structure from motion (SfM) for microscale 3D surface reconstruction. Sensors 2020, 20, 5599;
v. Khalil, M.; Ismanto, I.; Fu'ad, M. N. 3D reconstruction using structure from motion (SFM) algorithm and multi view stereo (MVS) based on computer vision. IOP Conf. Ser. Mater. Sci. Eng. 2021, 1073, 012066;
w. Mali, V. K.; Venu, P.; Nagaraj, M. K.; Kuiry, S. N. Demonstration of structure-from-motion (SfM) and multi-view stereo (MVS) close range photogrammetry technique for scour hole analysis. Sa dhana 2021, 46, 227;
x. Yu, Q.; Yang, C.; Wei, H. Part-wise AtlasNet for 3D point cloud reconstruction from a single image. Knowl.-Based Syst. 2022, 242, 108395;
y. Mur-Artal, R.; Tardos, J. D. ORB-SLAM2: An open-source SLAM system for monocular, stereo, and RGB-D cameras. IEEE Trans. Robot. 2017, 33, 1255-1262.

The computing server 106 also has an artificial intelligence computing module 111 (AI computing module 111), which may be used to enhance the data received from the live data collection module 105 with information that will facilitate identification of objects, shapes and depths of real-live elements captured on images of the live event received from the video capture device 102. The AI computing module 111 may function in conjunction with the stored data module 107 to target and match look-alike real-life elements captured in the images from the data streams of the video capture device 102 with known sample digitalized objects in the library of the stored data module 107. For example, shapes and forms of specific chairs captured by the images by the video capture device 102 and processed by the live data collection module 105 may be targeted and matched to shapes and forms of similar chairs in the stored data module 107, as such facilitating the processing of digitalizing of the chairs in the 3D model of the digital twin, as the dimensions, texture, and digital representations of these chairs have been stored in the stored data module 107 prior to capturing of the live event by the video capture device 102.

FIG. 1 shows that the computing server 106 has a 3D model rendering module 112. The 3D model rendering module 112 generates the digital twin based on the digital representations of the real-life elements present at the live event venue as well as the digital representations of the live event venue itself.

After the digital twin is generated by the computing server 106, the system 100 generates a virtual or augmented reality environment that is then communicated to or is constructed within a metaverse on the metaverse server 113. The metaverse server 113 may be a configuration of servers working as a centralized database or a disturbed ledger.

The metaverse server 113 communicates with the user devices 114 providing the user devices 114 with the virtual or augmented reality environment of the digital twin of the live event.

In some embodiments, the virtual or augmented reality environment of the digital twin of the live event may be stored on the metaverse server 113. In other embodiments only a portion of the virtual or augmented reality environment of the digital twin of the live event may be stored on the metaverse server 113 and other portions of the virtual or augmented reality environment of the digital twin of the live event are uploaded onto the metaverse server 113 following requests between the system 100 and the metaverse server 113.

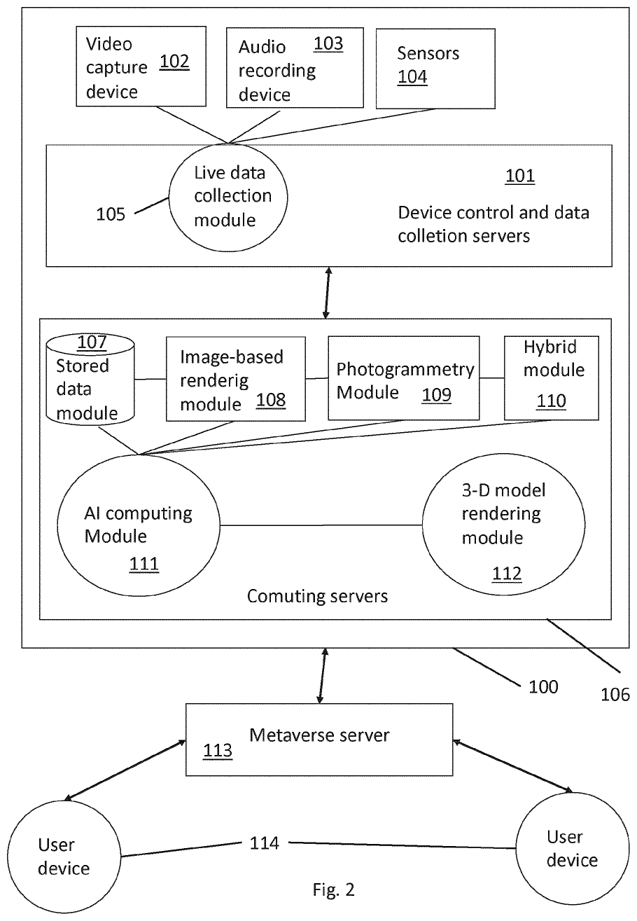

FIG. 2 shows an embodiment where the system 100 includes the video capture device 102, the audio recording device 103 and the sensors 104. In this embodiment, the system 100 has an integrated set of video capture device 102, the audio recording device 103 and the sensors 104 that may be located at a given venue, such as a stadium for example, that is designed to generate 3D models of events thereon by generating digital twins of the live events taking place there.

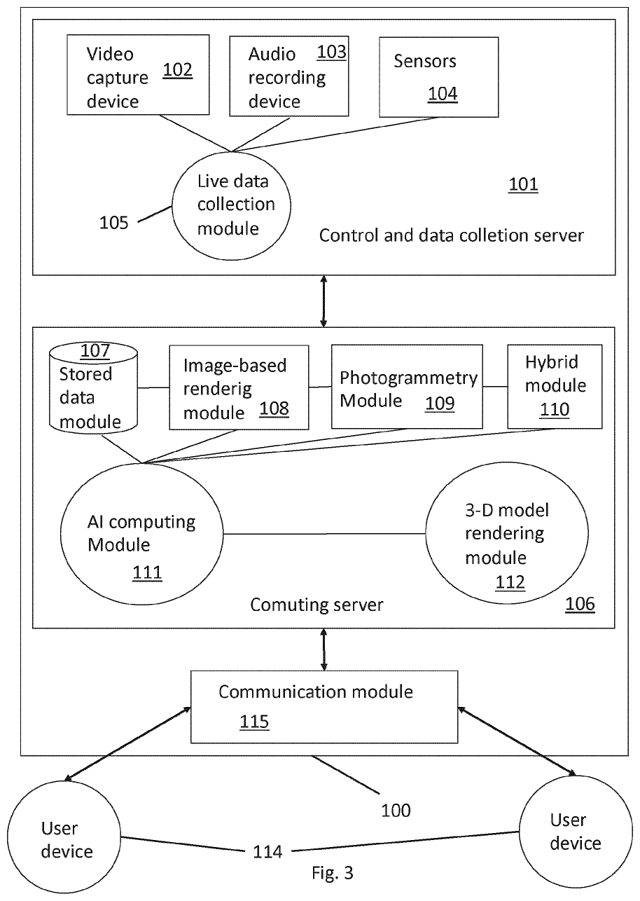

FIG. 3 shows an embodiment where the system 100 generates a virtual or augmented reality of a digital twin of a live event that is hosted on within the system 100 and that allows user devices 114 to communicate with the system 100 via the communication module 115.

It is understood that the system 100, the metaverse server 113, the communication module 115, the user devices 114 communicate via a network, which may be internet, ethernet, etc. The video capture device 102, the audio recording device 103 and the sensors 104 may also communicate with the control and data collection server 101 via a network or in any other way known in the art.

FIG. 4 shows an exemplary embodiment that does not have a stored data module 107. In this embodiment, the AI computing module 111 may access any additional data that may be required to generate a 3D model over the Internet.

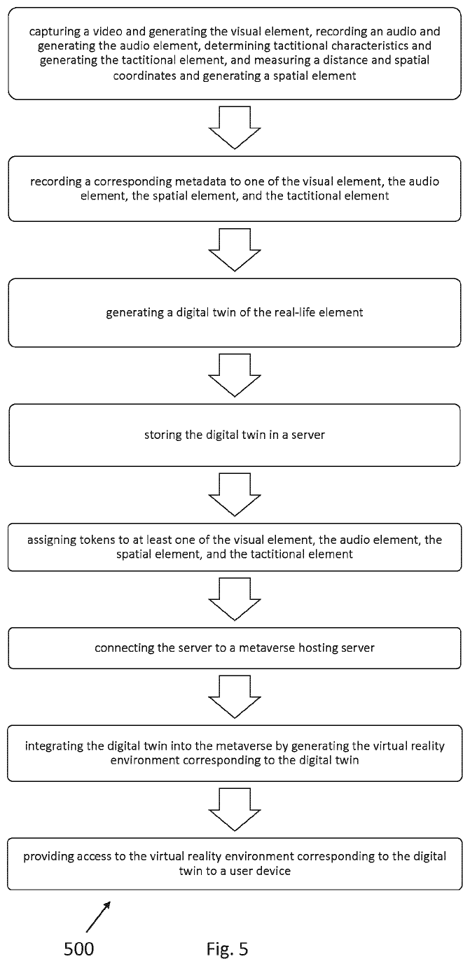

FIG. 5 shows an exemplary embodiment of a method 500 of generating a digital twin for creating a virtual or augmented reality environment in accordance with the present technology. The method 400 consists of the following exemplary steps:
a) capturing a video and generating the visual element, recording an audio and generating the audio element, determining tactitional characteristics and generating the tactitional element, and measuring a distance and spatial coordinates and generating a spatial element;
b) recording a corresponding metadata to one of the visual element, the audio element, the spatial element, and the tactitional element;
c) generating a digital twin of the real-life element;
d) storing the digital twin in a server;
e) assigning tokens to at least one of the visual element, the audio element, the spatial element, and the tactitional element;
f) connecting the server to a metaverse hosting server;
g) integrating the digital twin into the metaverse by generating the virtual reality environment corresponding to the digital twin;
h) providing access to the virtual reality environment corresponding to the digital twin to a user device.

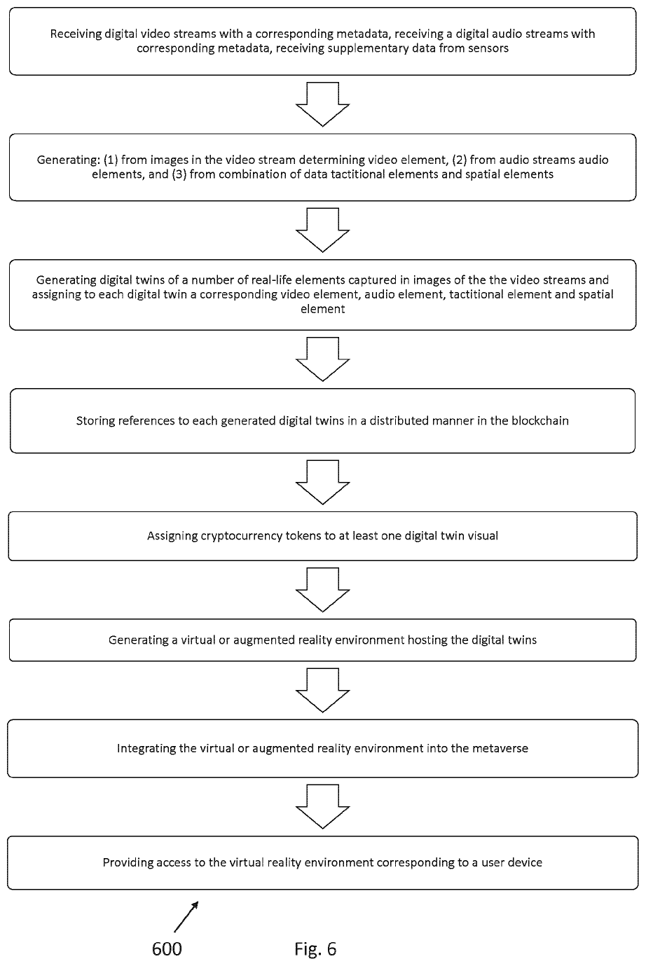

FIG. 6 shows an exemplary embodiment of a method 500 of generating a virtual or augmented reality environment having multiple digital twins of real-live elements that have cryptocurrency tokens assigned thereto. The virtual or augmented reality environment of the method 500 is integrated into a metaverse that provides access thereto to multiple user devices. The method has the following steps:
a) Receiving digital video streams with a corresponding metadata, receiving a digital audio streams with corresponding metadata, receiving supplementary data from sensors;
b) Generating: (1) from images in the video stream determining video element, (2) from audio streams audio elements, and (3) from combination of data tactitional elements and spatial elements;
c) Generating digital twins of a number of real-life elements captured in images of the the video streams and assigning to each digital twin a corresponding video element, audio element, tactitional element and spatial element;
d) Storing references to each generated digital twins in a distributed manner in the blockchain;
e) Assigning cryptocurrency tokens to at least one digital twin visual;
f) Generating a virtual or augmented reality environment hosting the digital twins;
g) Integrating the virtual or augmented reality environment into the metaverse;
h) Providing access to the virtual reality environment corresponding to a user device.

The method 600 assigns cryptocurrency tokens to the different virtual elements of the virtual or augmented reality environment. Digital twins herein relate to virtual object, which may include anyone of the following: a digitalized portion of a live performance, a digitalized song or an act, a particular set of seats at the digitalized performance, particular angles of view of the digitalized performance, a particular object, which may be a digital twin of a real-live object or it may be purely virtual object, such a dragon, an avatar, a fireball, etc., a sequence of digitalized images of a performance, a particular digital space that corresponds to a real physical space at the live event venue, and any other virtual object within the virtual or augmented reality environment. The cryptocurrency tokens may be fungible tokens or non-fungible tokens.

In some embodiments of the system 100 also cryptocurrency payment processing systems and integrated into the generated virtual or augmented reality environment, whereby a user may interact via the user device to acquire for a cryptocurrency token any digital twin withing the virtual or augmented reality environment, as well as the actual virtual or augmented reality environment itself. To enable this, the system 100 assigns permanent or semi-permanent references to each digital twin within the virtual or augmented reality environment on blockchain. It is understood by a person skilled in the art, that the system 100 may assign references to any blockchain currently existing on the marker or that may exist in the future. The assigning of references includes providing unique identifies to digital twins within a given blockchain.

The virtual or augmented reality environment may also be hosted on a distributed leger and be fully operatable on a blockchain technology. The computing power of the computing server 106 will then be distributed over a large number of machine each performing a separate task that is written into the blockchain and that may be accessed by the system 100 at request.

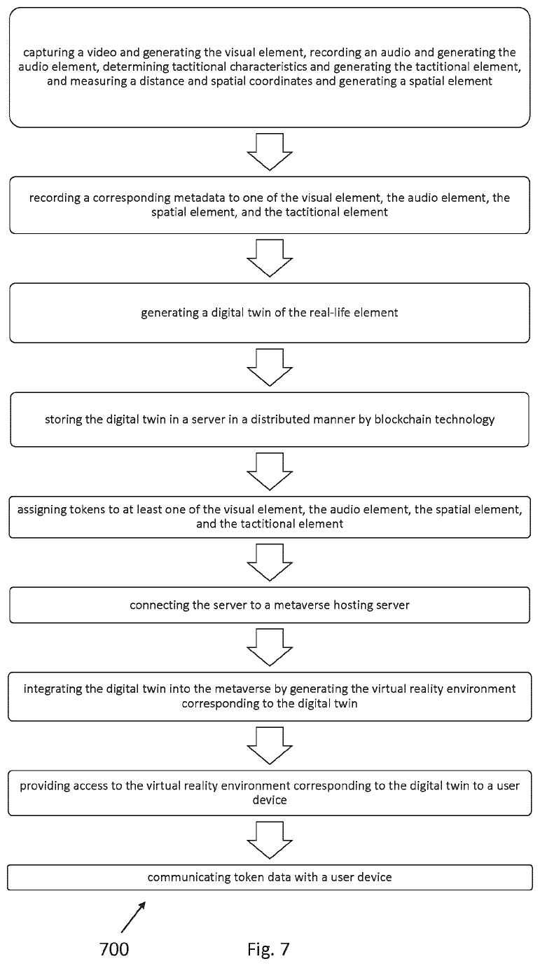

FIG. 7 illustrates a method 700 that enables the user to communicate token data via the blockchain between the user device and the virtual or augmented reality environment in the metaverse, after the virtual or augmented reality environment has been generated by the system 100. It is understood that many metaverses and many virtual or augmented reality environments may allow the users to only view and listen to the digital twins in the virtual or augmented reality environment, limiting other interactions of the user with the metaverse or the virtual or augmented reality environment. In some instances this may be optimize computing power of the servers 113 hosting the metaverse, or the communication modules 115 communicating with user devices 114.

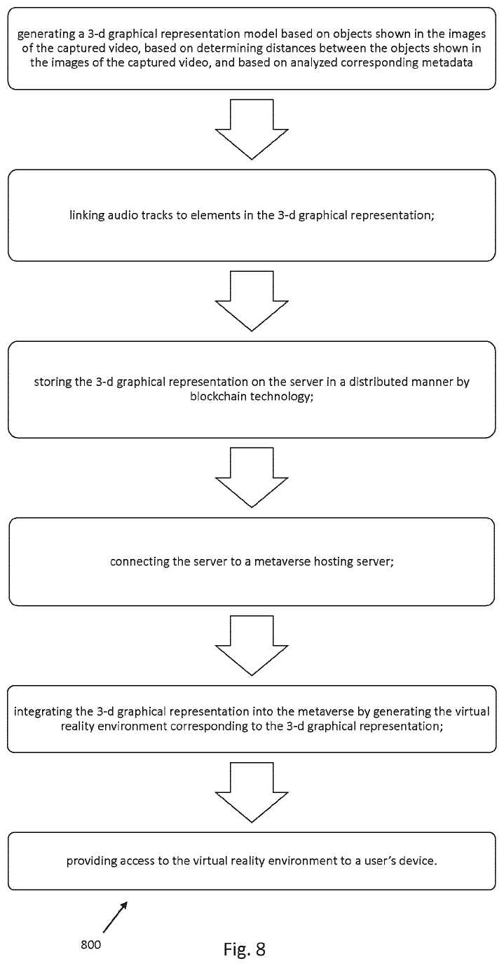

FIG. 8 illustrates an exemplary embodiment of a method 800 of generating a digital twin for virtual or augmented reality environment of a live event, where the system 100 initially generates a 3D model of the live event venue with digital representations of a suitable number of real-life elements from the venue and virtual objects integrated into the virtual or augmented reality environment by the system 100 or by the metaverse server 113. In some instances it may useful to first generate a full 3D virtual or augmented reality environment of a live event and then to add audio elements to the virtual or augmented reality environment. The audio elements may be added to different portions of the virtual or augmented reality environment of a live event differently, for example, in some locations of the virtual or augmented reality environment of a live event the sounds may be quieter and others may be louder. Also, the audio may be divided by different tracks, whereby each track corresponds to an individual source of sound. As the method 800 illustrates, the audio tracks that correspond to audio elements within the virtual or augmented reality environment of a live event may be added after the digital twin is generated. In some embodiments, the actual files with audio tracks may not be hosted in the servers of the system 100 and may be linked thereto via a network.

It is understood that in some embodiments, the system 100 may store the captured video data streams, audio data streams and data streams from sensors, and in other embodiments, the system 100 may use these data streams to generate the 3D model for the virtual or augmented reality environment of the live event and the actual videos, audio and sensor data may be stored on a separate server and the system 100 may link thereto its computing module 106 to generate the digital representations of real-live elements and the live event.

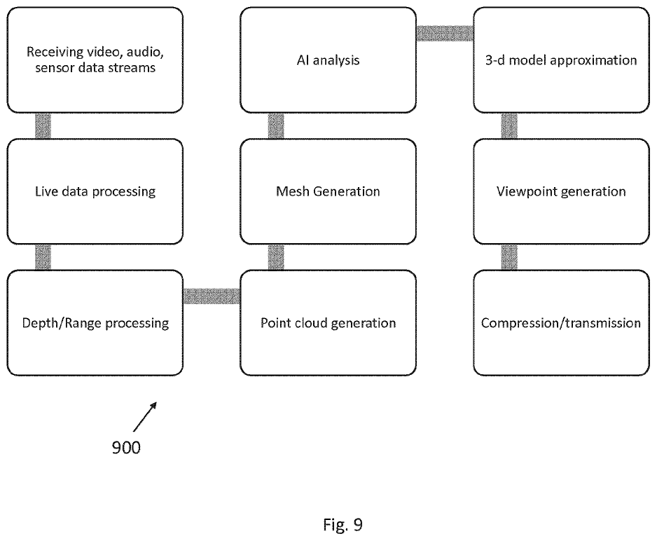

FIG. 9 illustrates an exemplary embodiment of a method 900 for generating a 3D model digital twin of a real-life element by the computing server 106, which includes the steps of:
a) receiving video, audio, sensor data streams;
b) live data processing;
c) depth/Range processing;
d) AI analysis and data enhancement processing;
e) mesh Generation;
f) point cloud generation;
g) 3D model approximation;
h) viewpoint generation;
I) compression/transmission

It is understood that a person skilled in the art may vary the method 900 and remain within the scope of the present technology.

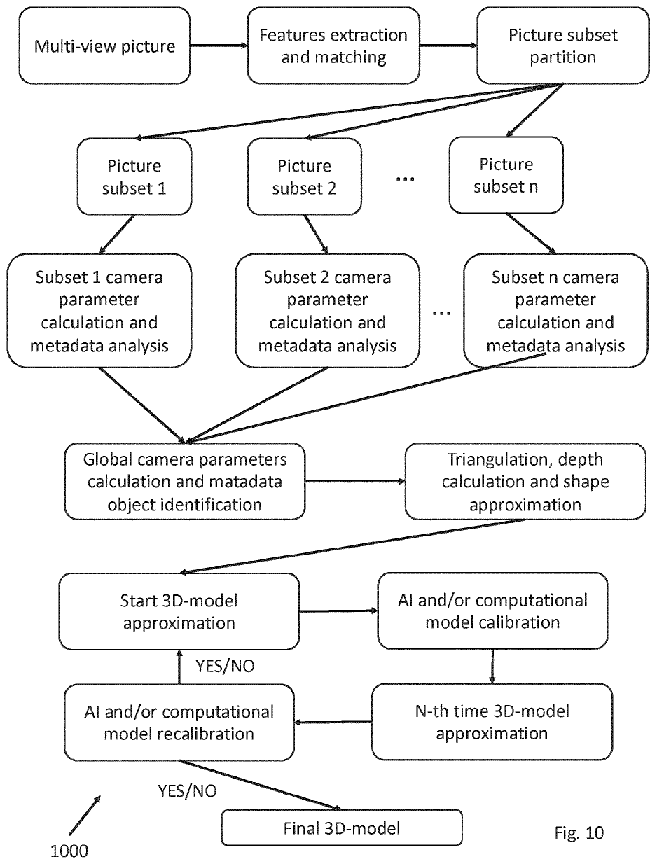

FIG. 10 illustrates an exemplary embodiment of a method 1000 of generating a 3D model of a digital twin of a real-live element or a live event venue from multi-view picture based on Multi-View 3D Reconstruction Technology.

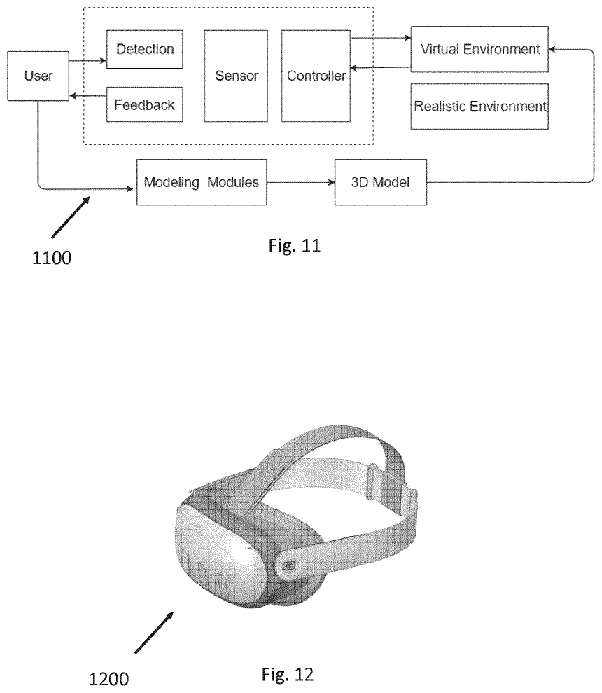

FIG. 11 illustrates an exemplary embodiment of a method 1100 of the user device interacting with the virtual or augmented reality environment. It is understood that any suitable model of user device interaction with the virtual or augmented reality environment is within the scope of the present technology.

FIG. 12 show an exemplary embodiment of a user device 1200. The user device 1200 is illustrated as a virtual reality headset, however, the user device also may include a smartphone, smart glasses, computer, a tablet, a gamepad, etc. (not illustrated herein).

It is understood that in some embodiments the system 100 may have a 3D model of the physical space of the venue where a live event is taking place stored in the stored data module 107. As such, the system 100 will capture only the video, audio and sensor data streams that relate to the actual performance that is taking place in the venue. The device control and data collection servers 101 will operate the live data collection module 105 to capture video, audio and sensor data streams of the performers, athletes and/or decorations of and animations of present at the live event venue. Then, the computing servers 106 will match the 3D model of the digital twin of physical space of the venue that is stored in the stored data module 107 with the digital twins generated by any one of the image-based rendering module 108, photogrammetry module 109 and/or the hybrid module 110. The AI computing module 111 may be activated to facilitate and/or enhance the compatibility between the pre-stored 3D digital twin of the physical space and the generated 3D digital twin of the live event. In some embodiments, the use of the AI computing module 111 may be omitted. The 3D model rendering module 112 generates the final 3D model of the digital twins corresponding to the physical space of the venue and of the live event, which generate the virtual or augmented reality environment.

The computing servers 106 allow the system 100 to generate a the virtual or augmented reality environment with sufficient accuracy in real time or in quasi real-time by incorporating the possibility to determine which real-life elements of the live events will be digitalized, which will not be digitalized by the system 100, and which may be digitalized by the system 100 during the course of the live event to be integrated into the virtual or augmented reality environment at a given time of the course of the live event. This technique may be applied to selectively identify real-time elements that require a large computing load to be digitalized. For example, fireworks, fires, fountains, etc. may be omitted from being digitalized altogether and instead may be replaced by virtual objects from a virtual objects' library stored in the stored data module 107 or available via the Internet.

In some embodiments of the present technology, the system 100 may generate a 3D model of a digital twin of a large physical venue of a live event, such as a stadium or a concert hall. The virtual or augmented reality environment generated will virtually correspond to the size of the venue. As a user places his/her avatar on the virtual or augmented reality environment, the user may be able to experience the live event from the location of his/her avatar. There may be instances, when many users will have their avatars in the virtual or augmented reality environment and each user may have different rights assigned thereto for interaction within the virtual or augmented reality environment. In order to determine which rights a user has and how he/she may interact with the virtual or augmented reality environment, the system 100 may generate virtual geofences around each avatar of each user or a group of users. The virtual geofences may also be generated at different locations of the virtual or augmented reality environment whereby each of the locations may have similar or different rights assigned thereto. Additionally, the geofences may be associated with cryptocurrency tokens. As such the geofences may allow the users to purchase or exchange virtual objects within the geofence using the tokens. Additionally, to enter a certain geofence a user may be required to purchase or exchange a cryptocurrency token, as a typical user may do in real life to enter a VIP zone of a live event, for example.

It is understood that the system 100 may use any suitable geofencing technology or equivalent, which is not limited to the use of the Global Positioning System (GPS) satellite network and/or local radio-frequency identifiers (such as Wi-Fi nodes or Bluetooth beacons) to create virtual boundaries around a location. The virtual or augmented reality environment geofences may be generated using the coordinate system of the metaverse, as well as matrices and other types of boundary calculation technologies. The geofences may be then paired with a software application on a user device or with a cryptocurrency token that responds to the boundary in some fashion as dictated by the parameters of the metaverse or the virtual or augmented reality environment.

The system 100 may be designed for operatively recording of live events, generating digital twins thereof and transferring data into a metaverse for the purpose of AR/VR/Mixed reality broadcasting. As such, examples of user devices 1200 include devices that enable AR/VR/Mixed reality broadcasting. The system 100 and the methods described herein provide technical solutions for the combination of attaching the live event broadcast or portions of the broadcast to a digital twin and generating a virtual reality or augmented reality environment therewith.

In some embodiments the systems and the methods described herein enable the possible combination of attaching the digital twin and broadcast or portions thereof to blockchain with the user of geofencing or equivalent technology, and cryptocurrency technology including NFTs. This enables the system 100 to integrate into the virtual reality or augmented reality environment any suitable combination of “Play to Earn” functionality for use in the metaverse live event. It is understood that there may be any combination of NFT's attached to virtual objects integrated into the virtual reality or augmented reality environment of the live event.

In some embodiments, the live data collection module 105 is configured to operate within the WEB3 framework and for generating data suitable for effective transferring to the metaverses.

In some embodiments, the blockchain technology is used by the system 100 for enabling of cataloging and re-distribution of virtual objects within the virtual reality or augmented reality environment during or after the live event.

As indicated above, the system 100 may use any suitable technology for 3D modelling for generating of digital twins of real-life elements.

Various techniques and mechanisms of the present technology will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors, cloud computing, distributed ledger technology, multiple-core processors, video cards or graphic accelerators, quantum computers or a combination thereof, while remaining within the scope of the present invention unless otherwise noted. Furthermore, the techniques and mechanisms of the present technology will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

In the above description, numerous specific details are set forth, but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A system for generating a digital twin in an interactive virtual reality environment, the digital twin corresponding to a live event, the system comprising:
a plurality of video capturing devices connected to a network,
each video capturing device for capturing videos of the live event, each captured video has a corresponding metadata;
a plurality of audio recording devices for recording audio of the live event;
a server configured to receive data from each video capturing device and each audio recording device;
the server operating a computing module, the module configured
to analyze the captured videos and the corresponding metadata,
to determine a spatial depth between images being captured by different video capturing devices,
to match each captured video to a coordinate matrix of a virtual space,
to match the audio to the coordinate matrix of the virtual space,
to generate the digital twin of at least a portion of the live event based on the captured videos, the corresponding metadata, the spatial depth, the predetermined set of coordinates and the coordinate matrix;
the server configured to generate a plurality of digital representations from multiple directions of the live event, including at least one 360-degree digital representation and a plurality of unidirectional digital representations, each digital representation corresponding to a viewing angle within the digital twin in the interactive virtual reality environment;
wherein, in operation, the digital representations and audio may be transmitted to a device of a user participating in the interactive virtual reality environment of the live event.

2. The system of claim 1, wherein the system is further configured to receive data from the device of a user, the data corresponding to user's interactions with the virtual reality environment.

3. The system of claim 2, wherein the computing module is further configured to calculate a threshold to determine real-life elements suitable for being within the digital representation of the digital twin in the virtual reality environment.

4. The system of claim 1, wherein the server is further configured to transmit the digital representations the device in real-time or a delayed time after the live event.

5. The system of claim 1, wherein the digital representations, audio recordings, corresponding metadata and corresponding coordinate matrix data are parsed and stored in a database by the system for at least partial on demand re-distribution.

6. The system of claim 1, wherein the digital representations, audio recordings, corresponding metadata and corresponding coordinate matrix data are stored in a distributed manner by blockchain technology.

7. The system of claim 6, wherein non-fungible tokens are assigned to at least a portion of the digital twin, including the digital representations, audio recordings, corresponding metadata and corresponding coordinate matrix data.

8. The system of claim 7, wherein the system includes a payment processor adapted for identifying a non-fungible token purchased by the user and assigning corresponding non-fungible tokens rights to the user.

9. The system of claim 1, wherein the system assigns a non-fungible token to the digital twin of the live event.

10. The system of claim 1, wherein the server uses artificial intelligence to generate digital representations.

11.

12.

13.

14.

15.

16.

17.

18.

19.

20.

21.

22.

23.

24.

25. A system for generating a digital twin in an interactive virtual reality environment, the digital twin corresponding to a live event, the system comprising:
a plurality of video data streams received via a network, each video stream corresponding to a predetermined set of coordinates of a physical space of the live event and having a corresponding metadata;
a plurality of audio data streams corresponding to a 3-D audio field of the live event;
a server configured to receive the video data streams and the audio data streams, the server operating a computing module, the module configured
to analyze the video data streams and the corresponding metadata,
to determine a spatial depth between images of the video data streams to match objects in each image to a coordinate matrix of a virtual space,
to match the 3-D audio field to the coordinate matrix of the virtual space,
to generate the digital twin of at least a portion of the live event based on the images, the corresponding metadata, the spatial depth, the predetermined set of coordinates and the coordinate matrix;
the server configured to:
generate a plurality of digital representations from multiple directions of the live event, including an at least one 360-degree digital representation and a plurality of unidirectional digital representations, each digital representation corresponding to a viewing angle within the digital twin in the interactive virtual reality environment; and
transmit the digital representations and audio to a user device via a network.

26. The system of claim 25, wherein the system is further configured to receive data from the user device, the data corresponding to user's interactions with the virtual reality environment.

27. The system of claim 26, wherein the computing module is further configured to calculate a threshold to determine real-life elements suitable for being within the graphical representation of the digital twin in the virtual reality environment and approximating digital representations of the real-life elements.

28. The system of claim 25, wherein the digital representations are transmitted to the device in real-time or a delayed time after the live event.

29. The system of claim 25, wherein the digital representations, audio, corresponding metadata and corresponding coordinate matrix data are parsed and stored in a database by the system for at least partial on demand re-distribution.

30. The system of claim 25, wherein the digital representations, audio, corresponding metadata and corresponding coordinate matrix data are stored in a distributed manner by blockchain technology.

31. The system of claim 30, wherein non-fungible tokens are assigned to at least a portion of the digital twin, including the digital representations, audio recordings, corresponding metadata and corresponding coordinate matrix data.

32. The system of claim 31, wherein the system includes a payment processor adapted for identifying a non-fungible token purchased by the user and assigning corresponding non-fungible tokens rights to the user.

33. The system of claim 25, wherein the system assigns a non-fungible token to the digital twin of the live event.

34. The system of claim 25, wherein the server uses artificial intelligence to generate digital representations.
